(19) United States
(12) Patent Application Publication
(10) Pub. No.: US 2022/0051375 A1
(43) Pub. Date: Feb. 17, 2022

(54) An inverse tone mapping method, system, device and computer readable medium

(71) Applicant: PEKING UNIVERSITY SHENZHEN GRADUATE SCHOOL, Shenzhen (CN)

(72) Inventors: Ronggang WANG, Shenzhen (CN); Chao WANG, Shenzhen (CN); Zhenyu WANG, Shenzhen (CN); Wen GAO, Shenzhen (CN)

(21) Appl. No.: 16/610,469

(22) PCT Filed: Feb. 18, 2019
(86) PCT No.: PCT/CN2019/075313

§ 371 Date: Nov. 1, 2019

(51) Int. Cl. G06T 5/00; G06K 9/46; G06N 3/04; G06T 3/60; G06T 5/50

(52) U.S. Cl. CPC G06T 5/009; G06K 9/4652; G06T 5/50; G06N 3/0454; G06T 3/60; G06K 9/4661

(57) ABSTRACT

The present disclosure discloses an inverse tone mapping method, system, device and computer readable medium The method of embodiment of the present application comprises: decomposing the original image into an illumination component and a reflection component, wherein the illumination component represents a global illumination condition of the image, the reflection component representing a color and texture detail of the image; recovering the illumination component to obtain a result of illumination component recovery; recovering the reflection component to obtain a result of reflection component recovery; combining the result of the illumination component recovery and the result of the reflection component recovery to obtain a recovery result image. Compared with the prior art, the inverse tone mapping method according to the embodiment of the present invention can greatly improve the effect of the image recovery.

### PRIORITY INFORMATION

The present application is a national stage filing under 35 U.S.C. § 371 of PCT/CN2019/075313, filed on Feb. 18, 2019. The application is incorporated herein by reference in its entirety.

### FIELD

The present disclosure relates to the technical field of computer, and more particularly relates to an inverse tone mapping method, system, device, and computer readable medium.

### BACKGROUND

Currently, 4K TV technology and related applications are rapidly developing. In the 4K TV standard, high dynamic range playback is an important part. However, since most media resources are still stored in a low dynamic range, reverse tone mapping of media resources is required to convert media resources from a low dynamic range to a high dynamic range.

In the prior art, the inverse tone mapping technology is a key link in the application field of 4K television technology and has high research value. In practical applications, inverse tone mapping is a morbid problem that requires recovery of information lost during quantization and compression of low dynamic range images. In general, inverse tone mapping usually proposes a network model through which the conversion of low dynamic range images to high dynamic range images is accomplished. However, the above method has drawbacks, and it cannot completely recover the information lost in the low dynamic range image. In particular, the network model cannot properly balance the recovery of different missing information, such as overexposed areas, underexposed areas, and color information.

### SUMMARY

In view of this, the embodiments of the present disclosure provide an inverse tone mapping method, system, device, and computer readable medium, which are used to improve the image restoration effect of reverse tone mapping in the prior art, which cannot meet expectations.

The embodiments of the present specification adopt the following technical solutions:

Embodiments of the present specification provide an inverse tone mapping method, comprising: decomposing the original image into an illumination component and a reflection component, wherein the illumination component represents a global illumination condition of the image, and the reflection component represents a color and texture detail of the image; recovering the illumination component to obtain a result of illumination component recovery; recovering the reflection component to obtain a result of reflection component recovery; combining the result of the illumination component recovery and the result of the reflection component recovery to obtain a recovery result image.

In an embodiment, the recovering the illumination component, comprising: recovering the illumination component according to an illumination component recovery network based on a full convolutional network.

In an embodiment, the recovering the illumination component according to an illumination component recovery network based on a full convolutional network, comprising: the illumination component recovery network comprises a convolution layer and an activation layer, and the activation function of the activation layer uses SELU.

In an embodiment, the recovering the illumination component according to an illumination component recovery network based on a full convolutional network, wherein: the illumination component recovery network includes first to seventh illumination component recovery layers in order from input to output; the number of feature channels of the first to sixth illumination component recovery layers is 64, and the number of feature channels of the seventh illumination component recovery layer is 3; the convolution kernel size of the first to sixth illumination component recovery layers is 3*3, and the step of the first to sixth illumination component recovery layers is 1, the convolution kernel size of the seventh illumination component recovery layer is 1*1 and the step of the seventh illumination component recovery layer is 1.

In an embodiment, the recovering the illumination component according to an illumination component recovery network based on a full convolutional network, wherein edge filling is performed by mirror symmetry.

In an embodiment, the recovering the illumination component according to an illumination component recovery network based on a full convolutional network, comprising: introducing a residual, and adding the input and output of the illumination component recovery network, and recovering the illumination component by learning the residual.

In an embodiment, the recovering the reflection component, comprising: recovering the reflection component according to a reflection component recovery network based on the U-Net structure.

In an embodiment, the recovering the reflection component according to a reflection component recovery network based on the U-Net structure, wherein: the reflection component recovery network includes first to tenth reflection component recovery layers in order from input to output; the first to fifth reflection component recovery layers and the tenth reflection component recovery layer are convolution layers, and the sixth to ninth reflection component recovery layers are deconvolution layers; the number of feature channels of the first to tenth reflection component recovery layers are 64, 128, 256, 512, 1024, 512, 256, 128, 64 and 3, respectively; the convolution kernel size of the first to fourth reflection component recovery layers is 3*3, the step of the first to fourth reflection component recovery layers is 2; and the convolution kernel size of the fifth to ninth reflection component recovery layers is 3*3, and the step of the fifth to ninth reflection component recovery layers is 1; the convolution kernel size of the tenth reflection component recovery layer is 1*1 and the step of the tenth reflection component recovery layer is 1.

In an embodiment, the recovering the reflection component according to a reflection component recovery network based on the U-Net structure, wherein in the deconvolution layer of the reflection component recovery network, firstly the bilinear interpolation upsampling is performed to enlarge the resolution of the feature map, and then the convolution operation is performed.

In an embodiment, the recovering the reflection component according to a reflection component recovery network based on the U-Net structure, wherein in the reflection component recovery network, a batch normalization operation is added to each layer.

The present application also proposes an inverse tone mapping system, comprising: a component decomposition module configured to decompose the original image into an illumination component and a reflection component, wherein the illumination component represents a global illumination condition of the image, the reflection component representing a color and texture detail of the image; a illumination component recovery module configured to recover the illumination component to obtain a result of illumination component recovery; a reflection component recovery module configured to recover the reflection component to obtain a result of reflection component recovery; and a component combining module configured to combine a result of the illumination component recovery and a result of the reflection component recovery to obtain a recovery result image.

The present application also proposes a computer readable medium, having stored thereon computer readable instructions executable by a processor to implement the method described in the embodiments of the present specification.

The present application also proposes an apparatus for information processing at a user equipment side, comprising a memory for storing computer program instructions and a processor for executing program instructions, wherein when the computer program instructions are executed by the processor, the apparatus is triggered to execute the method described in the embodiments of the present specification.

The above at least one technical solution used by the embodiment of the present specification can achieve the following beneficial effects: compared with the prior art, using the method according to the embodiment of the present invention to perform inverse tone mapping can greatly improve the image recovery effect.

### BRIEF DESCRIPTION OF THE DRAWINGS

The drawings described herein are provided to provide a further understanding of the present application and constitute a part of the present application, the illustrative embodiments of the present application and the description thereof are for explaining the present application and do not constitute an undue limitation of the present application. In the drawing:

FIG. 1 shows a flow chart of a method execution according to an embodiment of the present specification;

FIG. 2 shows a schematic diagram of a illumination component recovery network structure according to an embodiment of the present specification;

FIG. 3 shows a schematic diagram of a reflection component recovery network structure according to an embodiment of the present specification;

FIG. 4 shows the original image in an application scenario;

FIG. 5 shows an illumination component obtained according to an embodiment of the present specification for the original image shown in FIG. 4;

FIG. 6 shows a reflection component obtained according to an embodiment of the present specification for the original image shown in FIG. 4;

FIG. 7 shows a light component recovery result obtained according to an embodiment of the present specification for the illumination component shown in FIG. 5;

FIG. 8 shows a reflection component recovery result obtained according to an embodiment of the present specification with respect to the reflection component shown in FIG. 6;

FIG. 9 shows a recovery result image obtained according to an embodiment of the present specification based on FIG. 7 and FIG. 8;

FIG. 10 shows a block diagram of a system structure according to an embodiment of the present specification.

### DETAILED DESCRIPTION OF EMBODIMENTS

In order to make the purpose, technical solutions and advantages of the application clearer, the technical solutions of the present application will be clearly and completely described in the following with reference to specific embodiments of the present application and corresponding drawings. It is apparent that the described embodiments are only a part of the embodiments of the present application, and not all of them. All other embodiments obtained by a person of ordinary skill in the art based on the embodiments of the present application without creative work are the scope of the present application.

In general, inverse tone mapping usually proposes a network model through which the conversion of low dynamic range images to high dynamic range images is accomplished. However, the above method has drawbacks, and it cannot completely recover the information lost in the low dynamic range image. In particular, the network model cannot properly balance the recovery of different missing information, such as overexposed areas, underexposed areas, and color information.

In response to the above problems, an embodiment of the present specification proposes an inverse tone mapping method. In order to propose the method of the embodiment of the present specification, the present application firstly makes detail analysis of the actual application scenarios. In the prior art, one of the drawbacks of inverse tone mapping is that the recovery of different missing information, such as overexposed areas, underexposed areas, and color information, cannot be well balanced. Therefore, in an embodiment of the present specification, different parameter models are used to recover different feature attributes of the image, and then the recovery results of all the models are combined to obtain a final image restoration result.

Specifically, in practical applications, Rtinex theory is a theory widely used in digital image processing. It believes that digital images can be decomposed into illumination components and reflection components. The illumination components mainly represent the global illumination conditions of the image, and the reflection components. Represents the color and texture details of the image, and the two do not affect each other independently. Therefore, in an embodiment of the present specification, an original image (low dynamic range image) is decomposed into an illumination component and a reflection component based on Rtinex theory, wherein the illumination component represents a global illumination condition and a dynamic range of the image, and the reflection component represents the colors and details of the image. The two components are recovered separately, and finally the recovery results of the two components are combined based on the Rtinex theory to obtain the final restored result image (high dynamic range image).

In the above steps, the recovering operation of the illumination component and the reflection component respectively represents the expansion of the dynamic range and the recovery of the detailed texture. Recovering the two components separately is equivalent to decomposing the inverse tone mapping operation into two subtasks, and the two subtasks are independent of each other and do not affect each other. This not only improves the disadvantages of the single network model, but also avoids the recovery of different missing information, and reduces the complexity of the inverse tone mapping operation, and the recovery effect is more robust. Further, compared with the prior art, since the complexity of the inverse tone mapping operation of the embodiment of the present specification is greatly reduced, the parameter setting required in the implementation process is greatly simplified, which makes the professional ability relatively low. Ordinary users can also perform inverse tone mapping operations, which greatly improves the practicality and generalization of inverse tone mapping operations.

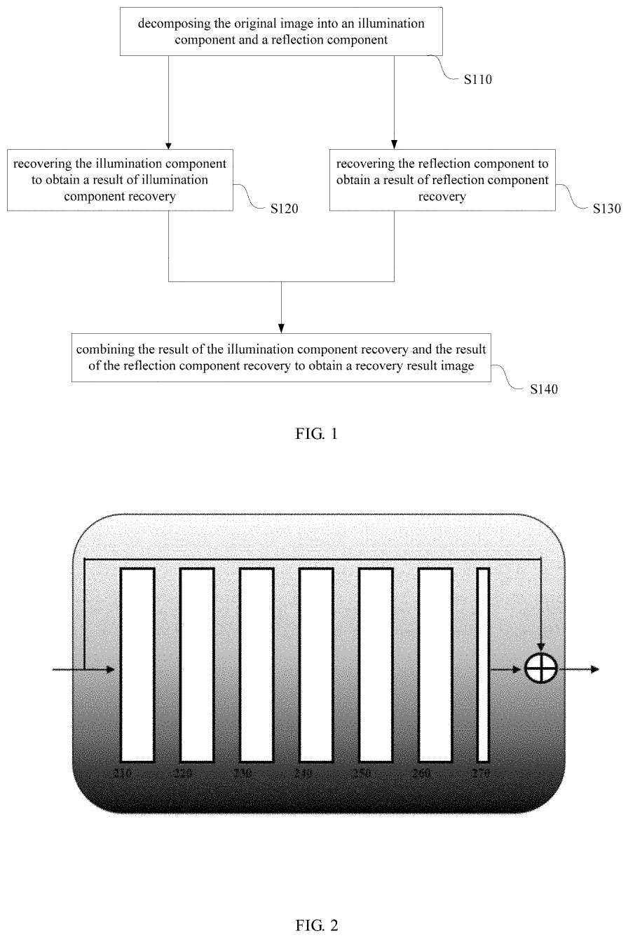

The technical solutions provided by the embodiments of the present specification are described in detail below with reference to the accompanying drawings. As shown in FIG. 1, in an embodiment, the method includes the following steps.

S110, decomposing the original image into an illumination component and a reflection component(low dynamic range image);

S120, recovering the illumination component to obtain a result of illumination component recovery;

S130, recovering the reflection component to obtain a result of reflection component recovery;

S140, combining a result of the illumination component recovery and a result of the reflection component recovery to obtain a recovery result imag(high dynamic range image).

Further, since the illumination component mainly represents the global illumination condition of the image, the reflection component represents the color and texture details of the image, and the two independently do not affect each other, in an embodiment of the present specification, different recovery strategies are used for different characteristics of the illumination component and the reflection component and their different recovery requirements. Specifically, different network models are used to recover the illumination component and the reflection component, respectively.

Specifically, since the illumination component represents global information, it is necessary to ensure the structural integrity of the illumination component to reduce information loss. In order to reduce the loss of information, it is necessary to avoid downsampling. Therefore, in an embodiment of the present specification, a full convolution network without downsampling is used for recovery for the illumination component. Specifically, in an embodiment, the illumination component is recovered according to a full-convolution network-based illumination component recovery network.

Further, in an embodiment, an illumination component recovery network based on a full convolutional network comprises a plurality of layers, wherein each layer comprises a convolution layer and an activation layer. In an embodiment, the activation function of the activation layer is determined based on field practice results. In an embodiment, the activation function of the active layer employs SELU. It should be noted here that in other embodiments of the present invention, the activation layer of each layer of the illumination component recovery network may also used other activation functions.

Further, in an embodiment, in order to further simplify the parameter setting, in an embodiment, the network structure setting of the illumination component recovery network with relatively better recovery effect in the general application scenario is determined according to the experimental record of the actual application scenario. In this way, the user can recover the illumination component according to the illumination component recovery network which has been previously set.

Specifically, in an embodiment, the specific structure of the illumination component recovery network for recovering the illumination component is set as follows: the illumination component recovery network includes first to seventh illumination component recovery layers in order from input to output; the number of feature channels of the first to sixth illumination component recovery layers is 64, and the number of feature channels of the seventh illumination component recovery layer is 3; the convolution kernel size of the first to sixth illumination component recovery layers is 3*3, and the step of the first to sixth illumination component recovery layers is 1, the convolution kernel size of the seventh illumination component recovery layer is 1*1 and the step of the seventh illumination component recovery layer is 1.

It should be noted that the specific setting of the above-mentioned illumination component recovery network structure is only a specific setting of the light component recovery network structure with relatively better recovery effect in some application scenarios. It is not necessary for the illumination component recovery network of all embodiments of the present specification to use the network structure setting. In the actual application scenario, the specific network structure setting of the illumination component recovery network may be set according to specific original image features and/or recovery requirements.

Further, in an embodiment, in the process of recovering the illumination component, in order to reduce the loss of information, it is necessary to ensure that the size of the feature image before and after the recovering is unchanged. Specifically, in an embodiment, in order to keep the size of the feature image unchanged, edge filling is performed by mirror symmetry in the process of recovering the illumination component.

Further, considering that the residual network can improve the learning efficiency and reduce the learning difficulty, in an embodiment, in order to improve the stability and efficiency of training the illumination component recovery network, a residual is introduced in the illumination component recovery network, adding the input and output of the illumination component recovery network together, and recovering the illumination component by learning the residual.

Specifically, as shown in FIG. 2, in an embodiment, the illumination component recovery network includes seven illumination component recovery layers just from number 210 to number 270. The number of feature channels of layers 210-260 is 64, the size of convolution kernel of them is 3*3, and the step of them is 1. The number of feature channels of layer 270 is 3, the size of convolution kernel of them is 1*1, and the step of them is 1.

Further, unlike the illumination component, the reflection component has a large amount of color texture information, and the information is crucial for the recovery of the overexposed area. So, in one embodiment, multi-scale information is used to recover the reflection components. Specifically, in an embodiment, in order to recover the reflection component by using multi-scale information, U-Net is used as the illumination component recovery network, that is, the recovery component is recovered according to a reflection component recovery network based on the U-Net structure.

Further, in an embodiment, in order to avoid the chessboard artifact, in the deconvolution layer of the reflection component recovery network, the bilinear interpolation upsampling is firstly performed to expand the resolution of the feature image, and then the convolution operation is performed.

Further, in an embodiment, in order to speed up the convergence rate, in the reflection component recovery network, a batch normalization operation is added to each layer.

Further, in order to further simplify the parameter setting, in an embodiment, the network structure setting of the reflective component recovery network with relatively better recovery effect in the general application scenario is determined according to the experimental record of the actual application scenario. In this way, the user can recover the reflected component based on the set back reflection component recovery network.

Specifically, in an embodiment, a specific structure of the reflection component recovery network based on the U-Net structure for recovering the reflection component is set as follows: the reflection component recovery network includes first to tenth reflection component recovery layers in order from input to output; the first to fifth reflection component recovery layers and the tenth reflection component recovery layer are convolution layers, and the sixth to ninth reflection component recovery layers are deconvolution layers; the number of feature channels of the first to tenth reflection component recovery layers are 64, 128, 256, 512, 1024, 512, 256, 128, 64 and 3, respectively; the convolution kernel size of the first to fourth reflection component recovery layers is 3*3, the step of the first to fourth reflection component recovery layers is 2; and the convolution kernel size of the fifth to ninth reflection component recovery layers is 3*3, and the step of the fifth to ninth reflection component recovery layers is 1;the convolution kernel size of the tenth reflection component recovery layer is 1*1 and the step of the tenth reflection component recovery layer is 1.

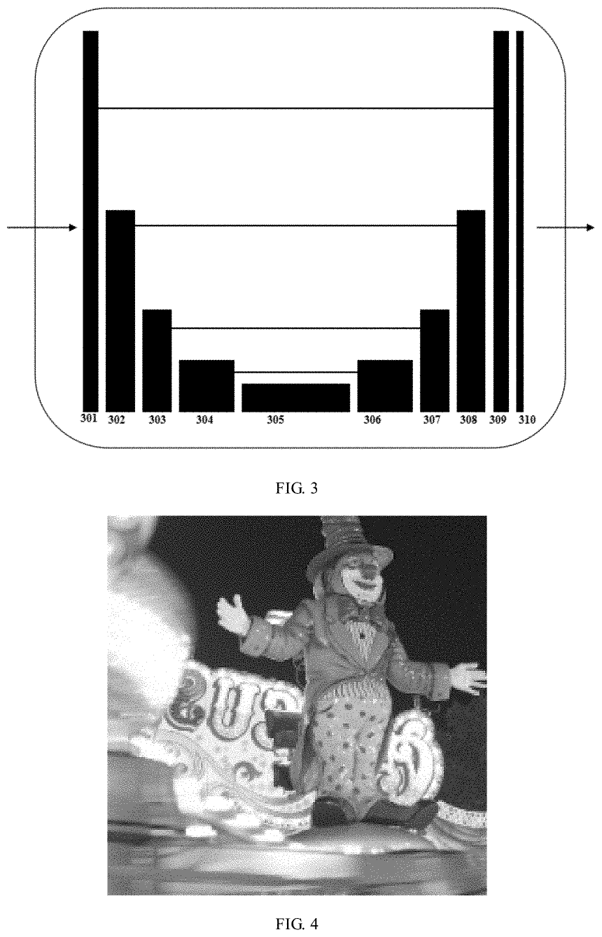

Specifically, as shown in FIG. 3, in an embodiment, the reflection component recovery network includes ten illumination component recovery layers just from number 301 to 310. Layers 301-305 and layer 310 are convolutional layers, and layers 306-309 are deconvolution layers; the number of characteristic channels of layers 301-310 are 64, 128, 256, 512, 1024, 512, 256, 128, 64 and 3 respectively; the convolution kernel size of layer 301˜304 is 3*3, the step of layer 301˜304 is 2, the convolution kernel size of layer 305˜309 is 3*3, the step of layer 305˜309 is 1, and the convolution kernel size of layer 310 is 1*. 1. The step of layer 310 is 1.

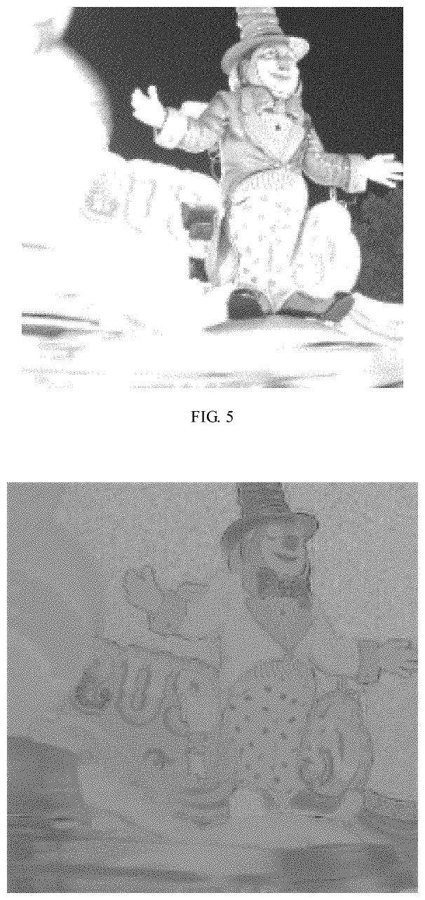

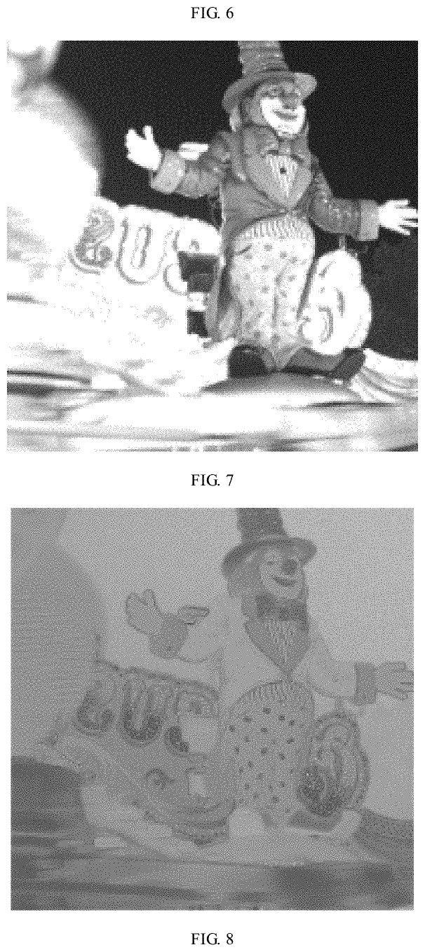

Specifically, in an application scenario, the original image (low dynamic range image) is as shown in FIG. 4, and the original image shown in FIG. 4 is decomposed into the illumination component as shown in FIG. 5 and the reflection component as shown in FIG. 6 according to the method of an embodiment of the present specification. Recovering the illumination component to obtain a result of illumination component recovery as shown in FIG. 7. Recovering the reflection component to obtain a result of reflection component recovery as shown in FIG. 8. Combining the result of the illumination component recovery and the result of the reflection component recovery to obtain a recovery result image (high dynamic range image) as shown in FIG. 9.

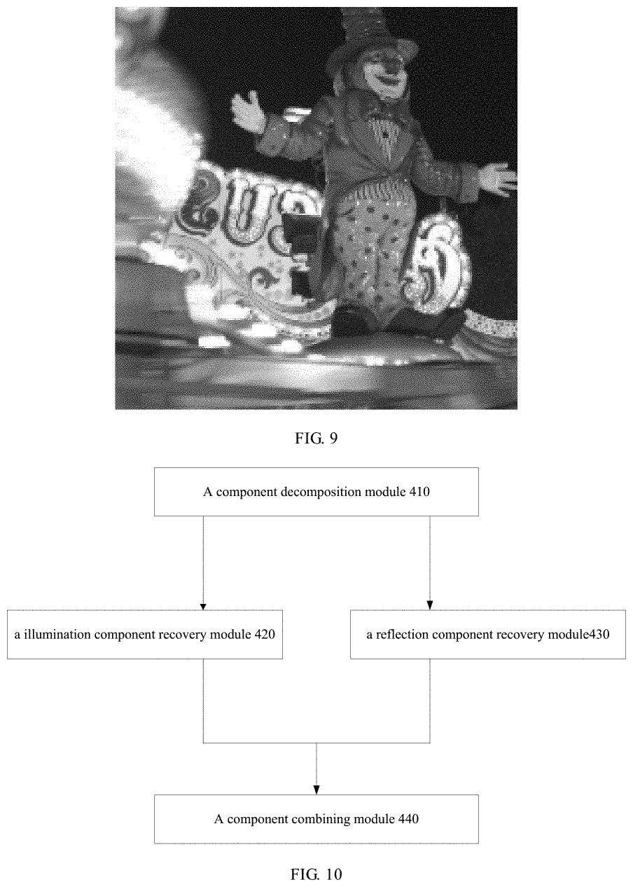

Further, based on the method of the embodiments of the present specification, an embodiment of the present specification further provides an inverse tone mapping system. Specifically, as shown in FIG. 10, in an embodiment, the system includes: a component decomposition module 410 configured to decompose the original image into an illumination component and a reflection component, wherein the illumination component represents a global illumination condition of the image, the reflection component representing a color and texture detail of the image; a illumination component recovery module 420 configured to recover the illumination component to obtain a result of illumination component recovery; a reflection component recovery module 430 configured to recover the reflection component to obtain a result of reflection component recovery; and a component combining module 440 configured to combine a result of the illumination component recovery and a result of the reflection component recovery to obtain a recovery result image.

Based on the method of the embodiments of the present specification, the embodiment of the present specification further provides a computer readable medium having stored thereon computer readable instructions executable by a processor to implement the method described in the embodiments of the present specification.

Based on the method of the embodiments of the present specification, an embodiment of the present specification further provides an apparatus for information processing at a user equipment side, the apparatus including a memory for storing computer program instructions and a processor for executing program instructions. Wherein, when the computer program instructions are executed by the processor, the apparatus is triggered to execute the method described in the embodiments of the present specification.

In the 1990s, it was clear that improvements to a technology were improvements to hardware (for example, improvements to circuit structures such as diodes, transistors, switches, etc.) or improvements to software (improvements to process flow). However, with the development of technology, many of the improvements to process flow can now be considered as direct improvements to the hardware circuit structure. Designers always get corresponding hardware circuit structure by programming the improved process flow into the hardware circuit. Therefore, it cannot say that an improvement of process flow cannot be implemented with hardware entity modules. For example, a Programmable Logic Device (PLD) (such as a Field Programmable Gate Array (FPGA)) is an integrated circuit whose logic function is determined by programming the device by a user. Designers programmatically “integrate” a digital system onto a single PLD without having to ask the chip manufacturer to design and fabricate a dedicated integrated circuit chip. Moreover, today, instead of manually making integrated circuit chips, the programming is mostly implemented by using “logic compiler” software, which is similar to the software compiler used in programming development, and the original code to be compiled also needs to be written in a specific programming language called Hardware Description Language (HDL), and there is not just one kind of HDL, but many kinds of HDL, such as BEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc., wherein VHDL (Very-High-Speed Integrated Circuit Hardware Description Language) and Verilog are the most commonly used. It should also be clear to those skilled in the art that, the hardware circuit that implements the logic process flow can be easily got only by using above hardware description languages to logically program the process flow and to program the process flow into the integrated circuit.

A controller can be implemented in any suitable manner, for example, the controller can take a form of, for example, a microprocessor or a processor, a computer readable medium storing the computer readable program code (for example, software or firmware) executable by the (micro)processor, logic gates, switches, Application Specific Integrated Circuit (ASIC), programmable logic controllers and embedded microcontrollers, and examples of the controllers include but not limited to the following microcontrollers: ARC 625D, Atmel AT91SAM, Microchip PIC18F26K20 and Silicone Labs C8051F320, and a memory controller can also be implemented as a part of the control logic of a memory. It is known to those skilled in the art that, in addition to implement the controller by the way of purely computer readable program code, it is entirely possible to implement the same function in a form of logic gates, switches, Application Specific Integrated Circuit (ASIC), programmable logic controllers, embedded microcontrollers, etc., by logically programming the method steps. Therefore, such a controller can be considered as a hardware component, and devices included therein for implementing various functions can also be regarded as structures within the hardware component. Or even, devices used to implement various functions can be regarded as software modules of implementation method and structures within the hardware component.

The system, device, module or unit illustrated in the above embodiments may be implemented by a computer chip or an entity, or by a product with a certain function. A typical implementation device is a computer. Specifically, the computer can be, for example, a personal computer, a laptop, a cellular phone, a camera phone, a smart phone, a personal digital assistant, a media player, a navigation device, an email device, a gaming console, a tablet, a wearable device, or a combination of any devices from above.

For the convenience of description, the above system is described as different units according to the functions thereof respectively. Of course, the functions of the respective modules or units can be performed in the same one or more items of software or hardware in an implementation of the invention.

Those skilled in the art should understand that the embodiments of this application can be provided as method, system or products of computer programs. Therefore, the embodiments of this disclosure may be realized by complete hardware embodiments, complete software embodiments, or software-hardware combined embodiments. On one or multiple storage media (including but not limit to disk memory, CD-ROM, optical memory etc.

The present description is described in terms of a flowchart, and/or a block diagram of a method, apparatus (system), and computer program product according to embodiments of the present specification. It will be understood that each flow and/or block of the flowcharts and/or block diagrams, and combinations of flows and/or blocks in the flowcharts and/or block diagrams can be implemented by computer program instructions. These computer program instructions can be provided to a processor of a general purpose computer, special purpose computer, embedded processor, or other programmable data processing device to produce a machine for the execution of instructions for execution by a processor of a computer or other programmable data processing device, means for implementing the functions specified in one or more processes and/or block diagrams of one or more blocks of the flowchart.

The computer program instructions can also be stored in a computer readable memory that can direct a computer or other programmable data processing device to operate in a particular manner, such that the instructions stored in the computer readable memory produce an article of manufacture comprising the instruction device, the device implements the functions specified in one or more blocks of a flow or a flow and/or a block diagram of the flowchart.

These computer program instructions can also be loaded onto a computer or other programmable data processing device such that a series of operational steps are performed on a computer or other programmable device to produce computer-implemented processing for execution on a computer or other programmable device, the instructions provide steps for implementing the functions specified in one or more of the flow or in one or more blocks of the flow chart and/or block diagram.

In a typical configuration, the computing device includes one or more processors (CPUs), input/output interfaces, network interfaces, and memory.

The memory may include non-persistent memory, random access memory (RAM), and/or non-volatile memory in a computer readable medium, such as read only memory (ROM) or flash memory. Memory is an example of a computer readable medium.

The computer readable medium includes both permanent and non-permanent, removable and non-removable, and the medium can be implemented by any method or technology. Information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disk read only memory (CD-ROM), digital versatile disk (DVD) or other optical storage, Magnetic tape cartridges, magnetic tape storage or other magnetic storage devices or any other non-transportable media that can be used for storage or information accessed by computing devices. As defined herein, computer readable media does not include temporary storage computer readable media, such as modulated data signals and carrier waves.

It is also to be understood that the terms “comprising ” or “containing” or any other variations are intended to encompass a non-exclusive inclusion, lead to a process, method, commodity, or device that includes a series of elements includes not only those elements but also other elements not explicitly listed, or elements that are inherent to the process, method, article, or device. In the absence of more restrictions, elements defined by the phrase “comprising a . . . ” do not exclude the presence of additional identical elements in the process, method, article, or device that includes the element.

This description can be described in the general context of computer-executable instructions executed by a computer, such as a program module. Generally, program modules include routines, programs, objects, components, data structures, and the like that perform particular tasks or implement particular abstract data types. It is also possible to practice the description in a distributed computing environment in which tasks are performed by remote processing devices that are connected through a communication network. In a distributed computing environment, program modules can be located in both local and remote computer storage media including storage devices.

The various embodiments in the present specification are described in a progressive manner, and the same or similar parts between the various embodiments may be referred to each other, and each embodiment focuses on the differences from other embodiments. In particular, for the system embodiment, since it is basically similar to the method embodiment, the description is relatively simple, and the relevant parts can be referred to the description of the method embodiment.

The aspects described above is only for the embodiments of the present specification, and is not intended to limit this application. Various changes and variations can be made to the application by those skilled in the art. Any modifications, equivalents, improvements, etc. made within the spirit and principles of the present application are intended to be included within the scope of the claims of the present application.

I/we claim:

1. An inverse tone mapping method, comprising:
decomposing the original image into an illumination component and a reflection component, wherein the illumination component represents a global illumination condition of the image, and the reflection components a color and texture detail of the image;
recovering the illumination component to obtain a result of illumination component recovery;
recovering the reflection component to obtain a result of reflection component recovery;
combining the result of the illumination component recovery and the result of the reflection component recovery to obtain a recovery result image.

2. The method according to claim 1, the recovering the illumination component, comprising: recovering the illumination component according to an illumination component recovery network based on a full convolutional network.

3. The method according to claim 2, the recovering the illumination component according to an illumination component recovery network based on a full convolutional network, comprising: the illumination component recovery network comprises a convolution layer and an activation layer, and the activation function of the activation layer uses SELU.

4. The method according to claim 2, the recovering the illumination component according to an illumination component recovery network based on a full convolutional network, wherein:
the illumination component recovery network includes first to seventh illumination component recovery layers in order from input to output;
the number of feature channels of the first to sixth illumination component recovery layers is 64, and the number of feature channels of the seventh illumination component recovery layer is 3;
the convolution kernel size of the first to sixth illumination component recovery layers is 3*3, and the step of the first to sixth illumination component recovery layers is 1, the convolution kernel size of the seventh illumination component recovery layer is 1*1 and the step of the seventh illumination component recovery layer is 1.

5. The method according to claim 2, the recovering the illumination component according to an illumination component recovery network based on a full convolutional network, wherein edge filling is performed by mirror symmetry.

6. The method according to claim 2, the recovering the illumination component according to an illumination component recovery network based on a full convolutional network, comprising:
introducing a residual, and adding the input and output of the illumination component recovery network, and recovering the illumination component by learning the residual.

7. The method according to claim 2, the recovering the reflection component, comprising: recovering the reflection component according to a reflection component recovery network based on the U-Net structure.

8. The method according to claim 7, the recovering the reflection component according to a reflection component recovery network based on the U-Net structure, wherein:
the reflection component recovery network includes first to tenth reflection component recovery layers in order from input to output;
the first to fifth reflection component recovery layers and the tenth reflection component recovery layer are convolution layers, and the sixth to ninth reflection component recovery layers are deconvolution layers;
the number of feature channels of the first to tenth reflection component recovery layers are 64, 128, 256, 512, 1024, 512, 256, 128, 64 and 3, respectively;
the convolution kernel size of the first to fourth reflection component recovery layers is 3*3, the step of the first to fourth reflection component recovery layers is 2; and the convolution kernel size of the fifth to ninth reflection component recovery layers is 3*3, and the step of the fifth to ninth reflection component recovery layers is 1;the convolution kernel size of the tenth reflection component recovery layer is 1*1 and the step of the tenth reflection component recovery layer is 1.

9. The method according to claim 7, the recovering the reflection component according to a reflection component recovery network based on the U-Net structure, wherein in the deconvolution layer of the reflection component recovery network, firstly the bilinear interpolation upsampling is performed to enlarge the resolution of the feature map, and then the convolution operation is performed.

10. The method according to claim 7, the recovering the reflection component according to a reflection component recovery network based on the U-Net structure, wherein in the reflection component recovery network, a batch normalization operation is added to each layer.

11. An inverse tone mapping system, comprising:
a component decomposition module configured to decompose the original image into an illumination component and a reflection component, wherein the illumination component represents a global illumination condition of the image, the reflection component representing a color and texture detail of the image;
a illumination component recovery module configured to recover the illumination component to obtain a result of illumination component recovery;
a reflection component recovery module configured to recover the reflection component to obtain a result of reflection component recovery; and
a component combining module configured to combine a result of the illumination component recovery and a result of the reflection component recovery to obtain a recovery result image.

12. A non-transitory computer readable medium, having stored thereon computer readable instructions executable by a processor to implement the method of claim 1.

13. An apparatus for information processing at a user equipment side, comprising a memory for storing computer program instructions and a processor for executing program instructions, wherein when the computer program instructions are executed by the processor, the apparatus is triggered to execute the method of claim 1.
